(19) United States
(12) Patent Application Publication
(10) Pub. No.: US 2005/0097248 A1
(43) Pub. Date: May 5, 2005

(54) System and method for establishing a communication between a peripheral device and a wireless device

(76) Inventor: Brian Harold Kelley, San Diego, CA (US)

Correspondence Address: Qualcomm Incorporated;Patents Department, 5775 Morehouse Drive, San Diego, CA, 92121-1714, US

(21) Appl. No.: 10/697,593

(22) Filed: Oct. 29, 2003

(51) Int. Cl. G06F 13/12

(52) U.S. Cl. 710/72

(57) ABSTRACT

A system, method and computer program for establishing communication between a peripheral device and programs resident on a wireless computer device. The device has a computer platform with a wireless communication portal and one or more resident programs, and the computer platform includes an operating system that manages wireless device resources and the interaction of the wireless device with other computer devices. When a peripheral device selectively communicates with the computer platform of the wireless device via a wired or wireless communication, the operating system of the wireless device identifies at least the type of peripheral device and links the peripheral device with one or more of the resident computer programs.

### BACKGROUND OF THE INVENTION

1. Field of the Invention

The present invention generally relates to computer devices having a wireless communication capability. More particularly, the invention relates to a system and method for establishing and controlling data communication between a peripheral device and the resident computer programs of a wireless computer device.

2. Description of the Related Art

It is known to link peripheral devices, such as printer, scanners, cameras, etc., to a personal computer (PC) so that the computer can utilize the peripheral device. The peripheral device is typically connected in a serial or parallel data communication with the computer platform of the PC. Specifically, serial input/output (I/O) (SIO) in a PC involves communicating with an external device by connecting it to the PC's serial line connection point. This mechanism enables an external device to communicate with the PC software using a serial data stream. The operating system of the PC, such as Windows or Linux, can detect the incoming initial communication from the peripheral device and determine the appropriate software or driver to operate the peripheral device, or otherwise control the communication.

In general, computer devices that primarily function to conduct wireless communications, such as mobile telephones and pagers, do not have a significant computer platform with a complex resident OS. Mobile device manufactures typically configure the device to communicate with any other computer device in a “data” mode. That is, the device processor or logic accepts simple data commands and often functions as a peripheral to the other device. For example, there are mobile devices that can provide wireless communication capability to other devices, such as a laptop computer. In a common configuration, a mobile telephone simply acts like a modem to a laptop computer, and initiates data service connections in response to telephone protocol dialing commands. Once a data connection is established, data to and from the laptop computer is passed through the mobile telephone unmodified, and the processor or logic of the mobile telephone is mostly bypassed.

A further problem is that for mobile devices that have a larger computer platform, the device typically has only a minimal OS and cannot devote significant resources for peripheral device communication. Consequently, even if the resident OS handled the incoming communication from the peripheral device to set up proper communications, the mobile device OS will not stay actively involved in managing the ongoing communication. In some instances, the mobile device OS does not have the ability to interact with the peripheral device such that the mobile device can control functionality of the peripheral device.

Accordingly, it would be advantageous to provide a system and method to provide a wireless computer device that can conduct complex communications with a peripheral computer device. The wireless device should have partial to complete control of the ongoing communications between the mobile device and the peripheral device. Further, the mobile device should be able to control the communication either partially or fully in software, such as with the device-resident OS. It is thus to the provision of such a system, method, and mobile device that the present invention is primarily directed.

### SUMMARY OF THE INVENTION

The present invention includes a wireless computer device, system, method, and computer program for communication between a peripheral device and the operating system of the wireless device. The wireless device includes a computer platform with at least a wireless communication portal, and can have other communication portals, both wired and wireless, and one or more resident computer programs. The computer platform also has an operating system that manages wireless device resources and the interaction of the wireless device with other computer devices, to include peripheral computer devices. A peripheral device will selectively communicate with the computer platform of the wireless device, through a wired or wireless connection, and upon the peripheral device communicating with the computer platform of the wireless device, the operating system of the wireless device will identify either the class of peripheral device or the specific device communicating, and then link one or more of the resident computer programs with the peripheral device. The device OS can either keep partial or full control of the communication between the peripheral device and the wireless device, or can hand over control of the communication to a linked resident program.

The method for communication between a peripheral device and the operating system of a wireless device includes the steps of starting a communication between a peripheral device and a wireless device having a computer platform with at least a communication portal, where the computer platform includes an operating system that manages wireless device resources and the interaction of the wireless device with other computer devices. The method then includes the step of determining, at the operating system of the wireless device, the identity of peripheral device that has started communication with the wireless device, and then linking, with the operating system, the peripheral device and one or more resident programs. A computer program can cause a wireless computer device to effect the steps of the method.

It is therefore an object of the wireless communications device to permit complex communications with a peripheral computer device, and not necessarily simple use of the wireless communication device as a modem. The wireless computer device can accordingly have partial to complete control of the ongoing communications between the computer platform of the wireless device and the peripheral device, and can use “plug-and-play” drivers and other mechanisms to assert control of the peripheral device at initial communication. The communication can occur in either serial or parallel data exchange, and through wired or wireless data links, or a combination thereof.

As embodied as part of the software of the wireless device operating system, the peripheral device communicates with an operating system entity such as a dynamic application or an internal object. Once the communication link is established between the internal application and the peripheral device, the operating system will determine the protocol used to facilitate their communication, or the operating system will interact with the peripheral device and jointly configure the optimal communication protocol. The operating system can control or relinquish control of the communication to the linked program as necessary. To learn about the peripheral device at the initial communication, the device OS can invoke a predefined protocol to discover the specific identity of the peripheral device, or at least of a class in which the peripheral device belongs, and then, in one embodiment, can determine the wireless device resident application or internal object entity that can service the peripheral device.

Other objects, advantages, and features of the present invention will become apparent after review of the hereinafter set forth Brief Description of the Drawings, Detailed Description of the Invention, and the claims.

### BRIEF DESCRIPTION OF THE DRAWINGS

FIG. 1 is a representative diagram of a peripheral device, shown as a camera, in a wired link with a wireless computer device, shown here as a mobile telephone.

FIG. 2 is a block diagram of the computer platform of a peripheral device in communication with the operating system on the computer platform of the wireless device.

FIG. 3 is a representative diagram of a wireless mobile network having wireless devices with peripheral device supporting capability.

FIG. 4 is a flowchart illustrating one embodiment of the process executing on the wireless device computer platform to communicate with a peripheral device.

### DETAILED DESCRIPTION OF THE INVENTION

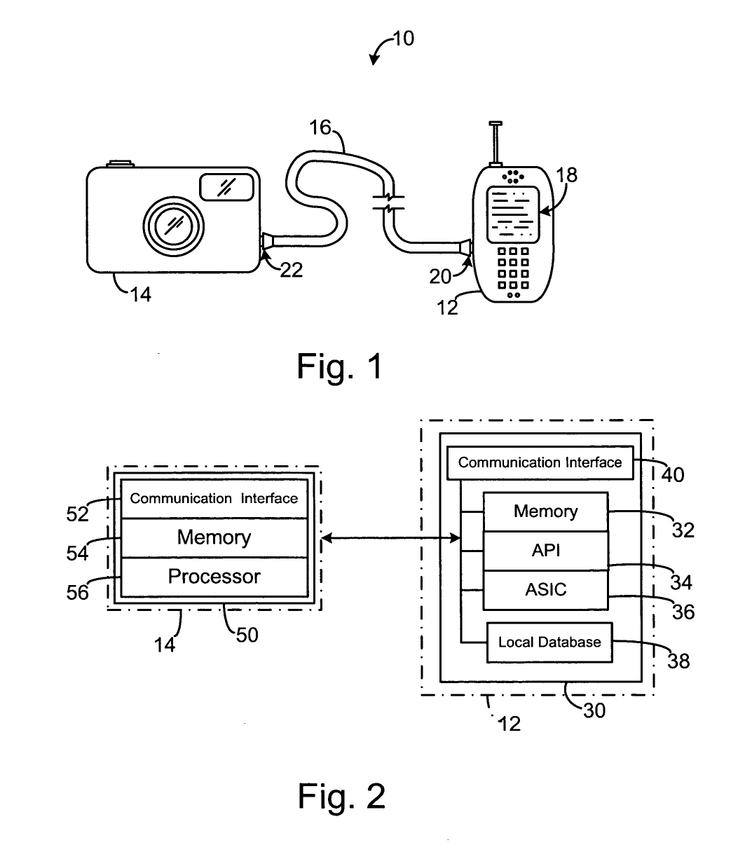

With reference to the figures in which like numerals represent like elements throughout, FIG. 1 illustrates a system 10 where a peripheral device, namely camera 14 is in a wired communication via serial line 16 with a wireless device, shown here as a mobile phone 12. The peripheral device 14 can transmit a specific command to call up the OS of the wireless device 12 on the connection, either wired (e.g. serial or USB, such as serial ports 20 and 22) or wireless (e.g. IRDA or RF). Upon receiving the call-up command, the OS of the wireless device 12 will establish the connection and communicate to the peripheral device 14 using a predefined protocol, which is further explained herein. Then the OS can link an appropriate program with the peripheral device and either partially or fully release control of the communication to the prgrom.

As shown in FIG. 1, a camera 14 is plugged in to the mobile telephone 12 can interact with the mobile telephone 12 to display pictures on the display 18, and the mobile telephone 12 can, in one embodiment, actuate the controls of the camera 14 to retrieve pictures for storage at the mobile telephone 12 and/or take further pictures. The wireless device 12 can be a mobile telephone, two-way pager, personal digital assistant (PDA), or other computer device having a wireless communication capability, and the peripheral device 14 can be a camera, viewer, printer, scanner, monitor, keyboard, joystick, mouse, speaker, or any other common peripheral device as would be known in the art.

As is more particularly shown in FIG. 2, the system 10 for communication between the peripheral device 14 and the operating system of a wireless device 12 where the wireless device 12 has a computer platform 30, and at least a communication portal or interface 40, and the computer platform 30 includes an operating system that manages wireless device resources and the interaction of the wireless device 12 with other computer devices, such as the peripheral device 14. One or more peripheral devices can selectively communicate with the computer platform 12 such that, upon the peripheral device 14 communicating with the computer platform 30, the operating system of the wireless device 12 will link the peripheral device 14 and one or more of the resident computer programs with the peripheral device 14, such as a driver, control program, etc.

More particularly, the wireless device 12 has a computer platform 30 that can receive and handle data sent from other computer telecommunication devices across a wireless network or through direct data communication. The computer platform 30 includes, among other components, an application-specific integrated circuit (“ASIC”) 36, or other processor, microprocessor, logic circuit, programmable gate array, or other data processing device. The ASIC 36 is installed at the time of manufacture of the wireless device and is not normally upgradeable. The ASIC 36 or other processor executes an application programming interface (“API”) layer 34, which includes the resident application environment, and can include the operating system loaded on the ASIC 36. The resident application environment interfaces with any resident programs in the memory 32 of the wireless device. An example of a resident application environment is the “Binary Runtime Environment for Wireless” (BREW™) software developed by Qualcomm® for wireless device platforms. BREW development tools are currently accessible at the Qualcomm website (www.qualcomm.com).

As shown here, the wireless device can be a cellular telephone 12, with a graphics display, but can also be any wireless device with a computer platform as known in the art, such as a personal digital assistant (PDA), a pager with a graphics display, or even a separate computer platform that has a wireless communication portal, and may otherwise have a wired connection to a network or the Internet. Further, the memory 32 can be comprised of read-only or random-access memory (RAM and ROM), EPROM, EEPROM, flash cards, or any memory common to computer platforms. The computer platform 30 can also include a local database 38 for storage of software applications not actively used in memory 32, as well as the computer code for the operating system. The local database 38 is typically comprised of one or more flash memory cells, but can be any secondary or tertiary storage device as known in the art, such as magnetic media, EPROM, EEPROM, optical media, tape, or soft or hard disk.

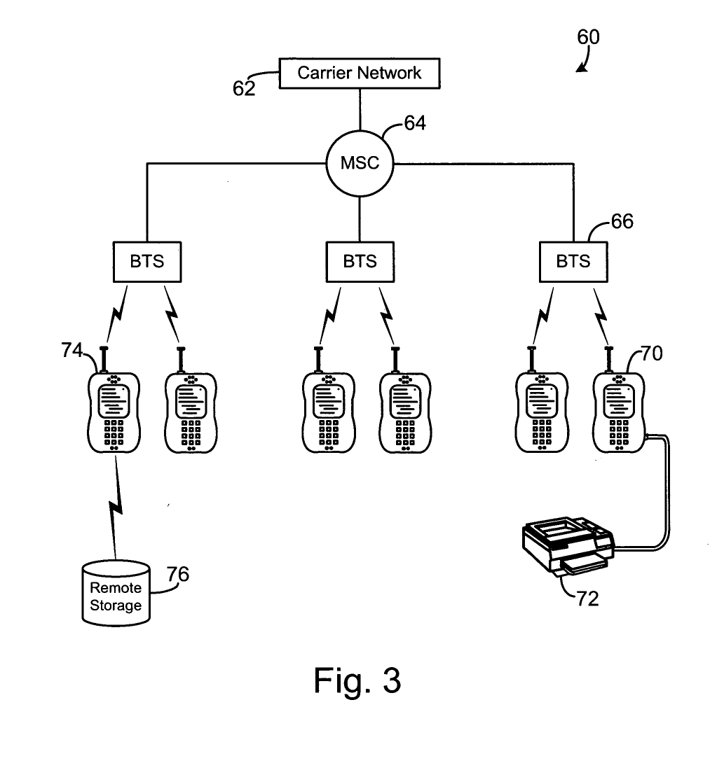

The wireless device, such as cellular telephone 12, has wireless communication capability through a wireless communication portal or communication interface 24 that selectively sends and receives data across a wireless network 60 (FIG. 3). The computer platform 30 resident application environment can communicate data across the platform, through the portal (interface 40), and can interact with any incoming communication stream and screen same for a predetermined response thereto.

Cellular telephones and telecommunication devices, such as cellular telephone 10, are being manufactured with increased computing capabilities and are becoming tantamount to personal computers and hand-held personal digital assistants (“PDAs”). These “smart” cellular telephones allow software developers to create software applications that are downloadable and executable on the processor, such as ASIC 36, of the wireless device 12. The wireless device, such as mobile telephone 12, can download and execute many types of applications, such as web pages, applets, MIDlets, games and stock monitors, or simply data such as news and sports-related data. The downloaded data or executable applications can be immediately displayed on a display of the wireless device 12 or stored in the local database 38 when not in use. The software applications can be treated as a regular software application or computer program resident on the wireless device 12, and the user can selectively upload stored resident applications from the local database 38 to memory 32 for execution on the API 34, i.e. within the resident application environment. Accordingly, a program to screen in the incoming communication connections can be loaded on the computer platform 30 at the time of manufacture of the device, or the program can be downloaded to the computer platform 30 across the wireless network 25.

The peripheral device 14, such as the camera, typically includes a computer platform 50 with its own resident communication interface 52, which can be a wired or wireless interface, and a resident memory 54 and central processor 56 or other logic. Thus, the camera 14, or other peripheral device can engage in duplex communication with any resident program of the wireless device 12, or perform other advanced functions.

FIG. 3 is a block diagram that more fully illustrates the components of the wireless network 60 in which the wireless devices 70 and 74 operate. The wireless network 60 is merely exemplary and can include any system whereby remote modules communicate over-the-air between and among each other and/or between and among components of a wireless network 60, including, without limitation, wireless network carriers and/or servers. The carrier network 62 controls messages (generally in the form of data packets) sent to a messaging service controller (“MSC”) 64. The carrier network 62 communicates with the MSC 64 by a network, the Internet and/or POTS (“plain ordinary telephone system”). Typically, the network or Internet connection between the carrier network 62 and the MSC 64 transfers data, and the POTS transfers voice information. The MSC 64 is connected to multiple base stations (“BTS”) 66. In a similar manner to the carrier network, the MSC 64 is typically connected to the BTS 66 by both the network and/or Internet for data transfer and POTS for voice information. The BTS 66 ultimately broadcasts messages wirelessly to the wireless devices, such as cellular telephones 70 and 74, by short messaging service (“SMS”), or other over-the-air methods known in the art.

Thus, on the wireless network 60, one wireless device 70 can place a voice or data communication attempt to another device, such as wireless device 74. Wireless device 70 is shown here as having a printer 72 in a wired connection such that the wireless device 70 can print data at printer 72. Wireless device 74 is shown as being in a wireless communication with data remote storage 76 whereby the wireless device 74 can store and retrieve data at the remote storage 76. In each instance, the operating system of the wireless device 70,74 can handle the communication with the peripheral device 72,76. In one embodiment, the wireless devices 70,74 can communicate through each other to access the peripheral devices in communication with the other wireless device. That is, wireless device 74 can access printer 72 through wireless device 70, and wireless device 70 can access remote storage 76 through wireless device 74. In such instance, the operating systems of the wireless devices will handle the appropriate data routing for the pass-through communications.

In an embodiment using the BREW operating system to control peripheral device communication, when a peripheral device, such as camera 14, starts communicating, it will initially communicate with the AT command processor (ATCOP). By issuing a command, the peripheral device informs the ATCOP to transfer the control of the particular SIO connection to the BREW SIO Command Processor (BSCOP). Once the peripheral device 14 gets a positive response from the operating system, the peripheral device 14 can issue commands to the BREW SIO command processor. These commands allow a peripheral device 14 to either initiate communication with one or more specific BREW applications or to perform other tasks on the wireless device 12.

In this embodiment, the BREW SIO also allows an application to unilaterally seize control of a serial port of the wireless device 12 dependant upon other clients being currently active on the serial port. ATCOP and BSCOP will typically yield to a requesting application, but other higher priority clients (such as service programming) can refuse to release the port. The specific situations that will prevent a peripheral device handling application from gaining control of the port will differ due specific wireless device manufacturing and configuration. Application-initiated communication with the peripheral device 14 is necessary to support communication with peripheral devices that do not interface BREW or the resident operating system. In application-initiated communication, it is often necessary to have the user of the wireless device 12 to coordinate either connecting the peripheral device 14 with launching the appropriate application, or for the user to assist in identifying at least the type of peripheral device.

For disconnection of a peripheral device 14 while in communication with a wireless device 12 resident application, in a peripheral device 12 initiated communication, on detection of device disconnection, the communication port is handed over to the ATCOP. Any further Read/Write calls to the port by the wireless device 12 resident application in communication will result in error. The wireless device 12 resident application can re-register for a reconnection of the previous port by calling the appropriate function or object, such as Writeable( ). In wireless device 12 resident application initiated service, if the peripheral device 14 is disconnected, the port or interface 40 is still controlled by the resident application. Any further Read/Write calls will still result in error, but the wireless device 12 resident application can give control of the port back to the ATCOP or maintain control.

In exiting a wireless device 12 resident application while the wireless device 12 is talking to a peripheral device 14, the port or interface controlling function or object will be closed by the application, which causes the port/interface to be handed over to the ATCOP. If the wireless device 12 resident application is the reentered, the standard protocol for obtaining a port or interface occurs.

The BREW interface can also handle unexpected data in the communication with the peripheral device 14. Wireless device 12 resident applications that explicitly open and control a port or interface recognize normal functionality of BSCOP and ATCOP, and respond appropriately when connected to peripheral devices that expect to be talking to ATCOP or BSCOP. Upon the receipt of errant data, the wireless device 12 resident application typically releases the port/interface and lets BREW decide the next action. In BREW, a DTR transition is the method used by the UARTs to detect peripheral device 14 disconnections, but in some cases, reliable detection may not be possible. For example, if a wireless device 12 resident application is talking to a specific peripheral device 14 which then changes during the communication. The wireless device 12 resident application, or a separate wireless device 12 resident error-checking application, should detect a peripheral device 14 change and surrender control of the port/interface so that the control goes back to ATCOP.

Below is a basic description of commands that can be issued by the connected device when in BSCOP mode. Each command is contained in a packet that begins with a two-byte tag and ends with a <CR> (ASCII 0x0D) character. An <LF> (ASCII0x0A) character following a command packet is ignored. Response packets begin with a two-byte tag and end in<CR><LF> (ASCII 0x0D 0x0A). The maximum packet size supported by BSCOP is 512 bytes.

Tags sent with commands should consist of two alphanumeric ASCII characters. The tag attached to a response is the same as the tag that was sent with its corresponding command. This is intended for use by devices to disambiguate responses. By sending a different tag with every command, the device can determine which command a response results from. This can be useful to synchronize communication when establishing the connection or recovering from data errors.

| Command | Description | |
|---|---|---|
| $BREW | “AT$BREW” is the command to the Wireless Device's | |
| | ATCOP to transfer control to BREW. If BSCOP is | |
| | already in control, this will be interpreted as a “$BREW” | |
| | command with a tag of “AT”, and the resulting response | |
| | packet (including the tag) will be “ATOK”. | |
| | As a result, when “AT$BREW” is sent to initiate | |
| | communication when the phone, the device can quickly | |
| | synchronize whether the port was in ATCOP or BSCOP | |
| | mode. | |
| | Responses | Description |
| | OK | The Wireless Device's ATCOP's |
| | | response to hand the SIO to BREW |
| | ERROR | The Wireless Device does not |
| | | understand the AT$BREW command |
| | | (ie No BREW SIO at that particular |
| | | port) |
| DEV:<devid>:<args> | This command is used to initiate communication with a | |
| | BREW application or object. BREW attempts to find the | |
| | handler using the identifier string. If the handler is found, | |
| | the START response is issued to the device. On failure, | |
| | the ERROR response is issued. | |
| | The <devid> value is the registry key used to find the | |
| | application handler. These keys are typically in a regular | |
| | form, such as <company code> or <devicename>, to avoid | |
| | naming conflicts. The devid is limited to the printable | |
| | ASCII characters excluding “*” (colon). | |
| | The <args> value will be passed to the launched | |
| | application. <args> value is a string of bytes excluding | |
| | the <CR> and <LF> characters. | |
| | Responses | Description |
| | OK | Command to the peripheral device |
| | | that the handler is found and the |
| | | resident application is being launched. |
| | | Once the START command is issued, |
| | | the peripheral device and the BREW |
| | | entity are connected and ready to |
| | | communicate using their predefined |
| | | protocol. |
| | ERROR:<xxxx> | Could not launch handler. <xxxx> |
| | | gives the error code (from |
| | | AEEError.h) as four hexadecimal |
| | | digits. Possible values specific to SIO |
| | | include: AEE_SIO_NOHANDLER |
| | | (handler was not found). Other |
| | | values, such as ENOMEMORY, are |
| | | always possible. |
| VER | Command to get BREW version | |
| | Responses | Description |
| | OK:<ver> | <ver> = BREW version string, in a |
| | | x.y.z.b format. (E.g., “1.0.1.18”). |
| APP:<clsid>:<args> | This command gives the CLSID of the wireless device 12 | |
| | resident application to open. BSCOP proceeds to launch | |
| | the application as it does with the DEV command, | |
| | although its class ID instead of a handler lookup specifies | |
| | the application. | |
| | This is less extensible than the DEV command, but is | |
| | useful for debugging and development. The <clsid> is a | |
| | string of hexadecimal letters that will be constructed into a | |
| | BREW classid. <args> is same as defined in the DEV: | |
| | Responses | Description |
| | OK | As in DEV. |
| | ERROR:<xxxx> | As in DEV. |
| URL:<url> | BSCOP will call ISHELL_BrowseURL( ) with the named | |
| | URL. This can be used to launch a browser, Mobile Shop, | |
| | or some other wireless device resident application, | |
| | depending upon which application has registered support | |
| | for the URL scheme. After failing to launch a required | |
| | application, the wireless device could use mshop URLs to | |
| | point the user to the required download option. <url> is of | |
| | same format as the DEV: <args>. | |
| | Responses | Description |
| | OK | Indicates that the associated wireless |
| | | device resident application has been |
| | | launched. |
| | ERROR:<xxxx> | Indicates that an associated wireless |
| | | device resident application could not |
| | | be launched. Any error in |
| | | AEEError.h can be retuned, but in |
| | | particular the following are most |
| | | likely: |
| | | ESCHEMENOTSUPPORTED |
| | | (Believe it or not, this is a BREW |
| | | error code). |
| | | ENOMEMORY |
| END | Informs BREW to give control back to Mobile ATCOP | |
| | Responses | Description |
| | OK | Only expected response. |

The following is an example BSCOP command sequence, where Lines beginning with “D:” represent what is sent by the peripheral device 14, and “P:” represents what the wireless device 12 sends to the peripheral device 14.
D: 01AT$BREW
P: 01ATOK
D: 02VER
P: 020K:3.0.0.1
D: 03DEV:BREW.siotest
P: 03ERROR OC01
D: 04DEV:BREW.siotest
P: 040K
D: 99END
P: 990K

The peripheral device 14 is not required to wait for a response before sending another command. For example, this sequence could occur:
D: 02VER
D: 03DEV:kb
P: 02OK:3.0.0.1
P: 03OK

One example of a BREW interface to permit duplex communication between the peripheral device 14 and the wireless device 12 is shown below. This interface extends the ISource interface by adding the Write and Writeable members:

```
AEEINTERFACE(IPort){
  INHERIT_ISource(IPort);
  Int (*GetLastError)(IPort * po);
  int32 (*Write)(IPort *pme, char *pBuf, int32 cbBuf);
  void (*Writeable)(IPort *pme, AEECallback *pcb);
  int (*IOCtl)(IPort *po, int nOption, uint32 dwVal);
  int (*Close)(IPort * po);
  int (*Open)(IPort * po, const char * szPort);
};
```

The GetLastError( ) function reports the last error that occurred during the operation of the IPort. The return value is one of the global BREW error codes defined in AEEError.h. The Open( ) function allows the app to bind the IPort to a physical port. When an instance of AEECLSID_SERIAL is created, an IPort is returned that is not associated with any physical port. IPORT_Open( ) must be used to indicate the name of the desired port. Open( ) is a non-blocking call that might return AEEPORT_WAIT when it cannot be immediately satisfied. The caller can then use IPORT_Writeable( ) to be notified of when the caller should try to access the port again.

When calling Open( ), the caller indicates the serial port desired by a zero-terminated string containing its name. BREW defines several names for types of ports that are generally available for peripheral devices. Serial port names consist of short ASCII sequences, allowing different mobile devices to support different ports in an extensible manner. Usually the main port at the bottom of a phone is an UART. All the UARTS are represented using strings, AEE_PORT_SIO1(“PORT1”), AEE_PORT_SIO2(“PORT2”) etc. The USB ports are represented using “USB1”, “USB2” etc. BREW also defines a special name, AEE_PORT_INCOMING (“inc”) that can be used to establish a communication link with a peripheral device 14 that is attempting to initiate communications with a specific wireless device 12 resident application.

For peripheral device 14 initiated communication with the wireless device 12, such as occurs if BREW executed a wireless device 12 resident application based on the DEV: string sent from the peripheral device 14, the wireless device resident application communicates with the peripheral device 14 through the IPort which received the command from the peripheral device 14. When a wireless device 12 resident application capable of communicating using SIO starts, the application will create an IPort interface using the CLSID of AEECLSID_SERIAL, and then call Open( ) with AEE_PORT_INCOMING. If Open( ) returns AEEPORT_WAIT, the application will then wait for the peripheral device 14 initiated connection by registering a callback using Writeable( ). When a peripheral device 14 is connected, the Writeable callback is called, prompting the wireless device 12 resident application to re-try the Open( ) operation, which will succeed.

If the user of the wireless device 12 starts a resident application without connecting the appropriate peripheral device 14, the wireless device 12 resident application still follows a similar process as described above and waits until the peripheral device 14 is connected. In this manner, a peripheral device 14 connected after the correspondence wireless device 12 resident application is launched can still be connected. Until the device is connected, Open( ) will continue to return AEEPORT_WAIT, and Writeable( ) will not execute.

AEESIO_PORT_INCOMING applies only to peripheral devices that have requested the running wireless device 12 resident application. If one wireless device resident application requests AEESIO_PORT_INCOMING and a peripheral device 14 is then connected that requests a different wireless device 12 resident application, the first application's Open( ) will not be satisfied. Instead, the other requested wireless device resident application will be launched and its attempt to open AEESIO_PORT_INCOMING will succeed. AEESIO_PORT_INCOMING can refer to any serial port or interface. A wireless device 12 can have multiple UARTs or multiple USB virtual serial ports, each of which could accept peripheral device 14 initiated connections.

For wireless device 12 resident application-initiated communication, the resident application creates an IPort interface using the Open( ) function. The port string argument determines which port is opened. The port ids supported by BREW are given in AEESio.h. For example, to open the main serial port, the AEESIO_PORT_SIO1 string is used. The Open( ) can fail due to multiple reasons such as non-availability (e.g. service programming in progress, wireless device “busy,” no-permission for open), no such port, etc. In this case, the Writeable callback gets called and a call to GetLastError( ) reports the error particulars.

When an IPort is closed, it is dissociated from the physical port, and the port is given back to the OS (ATCOP). Port objects will be also closed implicitly when all references to the object are released, but the Close( ) function is provided to allow explicit closing. The explicit closing of the objects is advantageous when different layers or modules of the wireless device resident applications use the same port object. This also allows an IPort to be reused because once it is in the closed state Open( ) can be called again and the open process iterated.

Serial port configuration occurs from the IOCtl flags AEESIO_IOCTL_SCONFIG and AEESIO_IOCTL_GCONFIG that are used to set and get configuration using the AEESIOConfig data structure as defined in AEESio.h. AEESIOConfig has information to control a UART such as baud rate, parity, stop bits etc. In the case of virtual serial ports, such as USB-based virtual serial ports, some or all of these settings might be ignored. As all entries of the AEESIOConfig may not be supported by an implementation the IPort, the return value of SUCCESS may not really mean that all options are set. Getting the configuration, after setting it, returns the current changed configuration. For example, if a specific baud-rate can not be set, the nearest supported baud-rate may be set. Setting a baud-rate to 38500 may actually set the real configuration to the nearest supported baud rate of 38400. The IOCtl also supports options to adjust internal buffer sizes, setting triggers (e.g. minimum number of bytes before making the state readable) for doing efficient reads.

The wireless device 12 resident applications register with the OS to specific the specific peripheral devices, or class(es) of peripheral devices the applications support so the resident application can be informed once the peripheral device is in communication with the wireless device 12. In BREW, the registration information is stored in the wireless device 12 resident application MIF file which can be updated using the MIF editor, typically as a device id string of the MIME Type. A base peripheral device class will have a predetermined handler type, such as the handler type for SIO devices defined in the AEESio.h as AEECLSID_HTYPE_SERIALDEVICE (0x01011be6). The handler class id will be same as the wireless device 12 resident application CLSID.

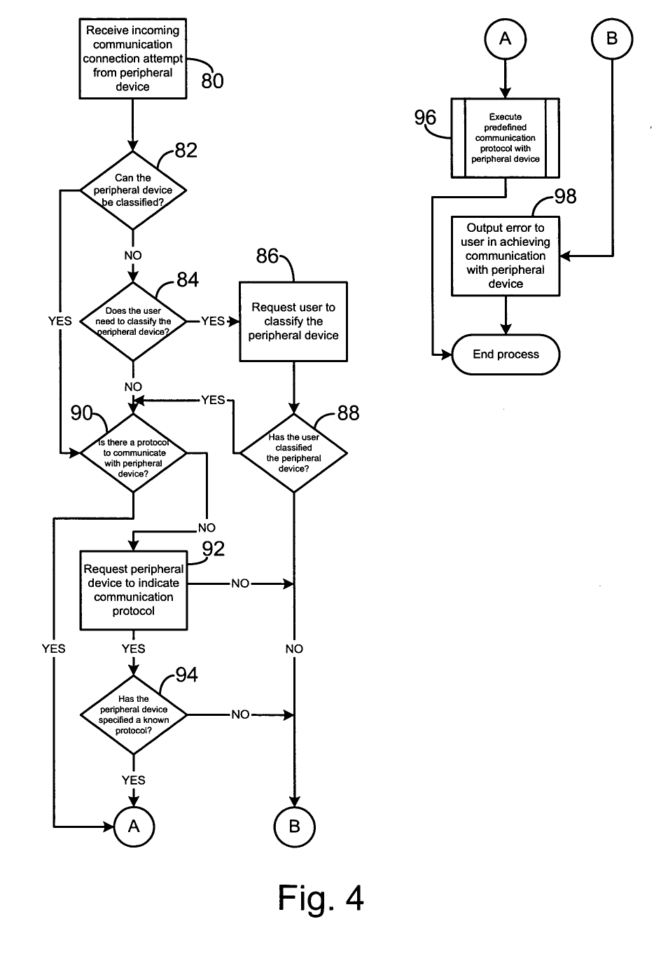

To more fully illustrate the process executing on the wireless device 12 computer platform 30 to communicate with a peripheral device 14, FIG. 4 is a flowchart illustrating one embodiment thereof. The wireless device 12 receives an incoming communication attempt from the peripheral device 14, as shown at step 80, and then a determination is made as to whether the peripheral device 14 can be classified, or otherwise identified, as shown at decision 82. The process can start at either the plug-in of a peripheral device 14 to the wireless device 12. Alternately, the user of the wireless device 12 can request the beginning of communication at the wireless device 12, and the wireless device will initiate the communication, and can start the process at step 92 which is further described herein. The identification or classification can occur from an identifier sent from the peripheral device 14 in the initial communication, or the information can be ascertained by the OS of the wireless device 12, such as through probing commands, review of the incoming data stream, or other methods as known in the art. If the peripheral device 14 can be identified at decision 82, then the process forwards to make a determination as to whether there is a known protocol for communication with that class or specific peripheral device 14, as shown at decision 14.

Otherwise, if the peripheral device 14 cannot be identified at decision 82, a determination is then made as to whether the user needs to classify or otherwise identify the peripheral device 14 as shown at decision 84. In other words, the peripheral device may not be able to bridge any communication with the wireless device 84 and decision 84 makes the determination if user intervention may provide a correct identification of the class or peripheral device such that a communication protocol can occur. If the user does need to identify the peripheral device 14 at decision 84, the user is requested to identify or classify the peripheral device, as shown at step 86, and then a determination is made as to whether the user had identified or classified the peripheral device 14 as shown at decision 88. If the user has not identified or classified the peripheral device 14 at decision 88, or possibly has indicated that the peripheral device 14 is not identifiable given a menu of limited choices of possible classes for the peripheral device 14, the process then outputs an error to the user in achieving a communication connection with the peripheral device 14, as shown at step 98 and the process terminates.

Otherwise, if the user has identified or classified the peripheral device 14 at decision 88, or if the user does not need to identify or classify the peripheral device 14 at decision 84, or if the peripheral device was classified or identified at decision 82, a determination is then made as to whether there is a predefined protocol to handle communication with the peripheral device 14 as shown at decision 90. If there is a predetermined protocol to handle communication with the peripheral device 14 at decision 90, then the predetermined communication protocol is executed to allow communications with the peripheral device 14 as shown at predetermined process 96 and then the process terminates at the end of communication session between the wireless device 12 and the peripheral device 14. Otherwise, if there is not a predetermined protocol at decision 90 then a request is made to the peripheral device 14 to indicate a communication protocol, as shown at step 92. In other words, the wireless device OS will prompt the peripheral device 14, typically through a universal handshaking command, to return data indicating the communication protocol the peripheral device 14 uses to communicate.

A determination is then made as to whether the peripheral device 14 has specific a known communication protocol at decision 94. If the peripheral device 14 has not specified a known protocol, or had specified an unknown protocol at decision 94, an error is output to the user in achieving a connection with the peripheral device 14, as shown at step 98, and then the process terminates. Otherwise, if the peripheral device 14 has specified a known communication protocol at decision 94, the predetermined communication protocol is executed to engage in communication with the peripheral device 14 as shown at predetermined process 96, and then the process terminates at the end of the communication session. The process will iterate at step 80 upon another communication request from the same, or a new peripheral device 14.

The present system therefore provides a method for communication between a peripheral device 14 and resident computer programs on the computer platform 30 of a wireless device 12, comprising the steps of starting a communication between a peripheral device 12 and the computer platform 30 of the wireless device 12, the computer platform 30 including an operating system that manages wireless device resources and the interaction of the wireless device 12 with other computer devices (such as peripheral device 14), and one or more resident computer programs, and determining, at the operating system of the wireless device, the identity of peripheral device 14 that has started communication with the wireless device 12, and then linking, with the operating system, the peripheral device 14 and one or more of the resident computer programs. In other words, one the wireless device 120S establishes a satisfactory communications with the peripheral device 14, the device OS can retain control of the communication, or can relinquish control to another resident program.

The step of starting a communication between a peripheral device 14 and a wireless device 12 can occur through a wired or a wireless connection to the computer platform 30 of the wireless device 12. Further, the method can include the steps of: sending a device class identifier to the operating system of the wireless device 12, and then selecting at the operating system the appropriate handler for that peripheral device 14 based upon the selected class. Alternately, the method can include the steps of: sending a specific identifier to the operating system of the wireless device 12 at the beginning of communication, and identifying, at the operating system, the specific peripheral device 14 in communication based upon the specific identifier of the peripheral device 14 given at the beginning of communication. The step of starting a communication between a peripheral device 14 and a wireless device 12 can also occur through the communication portal or interface 40 of the computer platform 30.

In view of the method being executable on the computer platform of a wireless computer device, the invention includes a computer readable medium capable of causing a computer device to perform the steps of the method. The computer readable medium can be the memory 32 of the computer platform 30. In the context of FIG. 4, the present method may be implemented, for example, by operating portion(s) of the wireless network 60 and/or any computer device, such as mobile phones 70 and 74, to execute a sequence of machine-readable instructions. The instructions can also reside in various types of signal-bearing or data storage primary, secondary, or tertiary media, either partially or fully loadable onto the computer platform 30. The media may comprise, for example, RAM (not shown) accessible by, or residing within, the components of the wireless network 60. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the foregoing disclosure shows illustrative embodiments of the invention, it should be noted that various changes and modifications could be made herein without departing from the scope of the invention as defined by the appended claims. Furthermore, although elements of the invention may be described or claimed in the singular, the plural is contemplated unless limitation to the singular is explicitly stated.

1. A system for communication between a peripheral device and the operating system of a wireless device, comprising:
a wireless device having a computer platform, and at least a communication portal, the computer platform including an operating system that manages wireless device resources and the interaction of the wireless device with other computer devices, the computer platform including one or more resident programs; and
at least one peripheral device that selectively communicates with the computer platform of the wireless device;
wherein upon the peripheral device communicating with the computer platform of the wireless device, the operating system of the wireless device at least linking one or more resident programs with the peripheral device.

2. The system of claim 1, wherein peripheral device communicates through a wired connection to the computer platform of the wireless device.

3. The system of claim 1, wherein the peripheral device communicates through a wireless connection to the computer platform of the wireless device.

4. The system of claim 1, wherein the peripheral device sends a class identifier to the operating system of the wireless device and the operating system determines the type of peripheral device communicating with the wireless device, and selects the appropriate handler for that peripheral device based upon the class identifier.

5. The system of claim 1, wherein the operating system of the wireless device identifies the specific peripheral device in communication based upon a specific identifier of the peripheral device given at the beginning of communication.

6. The system of claim 1, wherein peripheral uses the wireless device as a communication portal to the Internet.

7. The system of claim 1, wherein the peripheral device uses the wireless device as a communication portal over a telephone network.

8. The system of claim 1, wherein the peripheral device communicates with the computer platform of the wireless device through the communication portal of the computer platform.

9. A system for communication between computer devices, comprising:
a wireless communication means for communicating across a wireless network, the wireless communication means including a control means for managing wireless communication means resources and the interaction of the wireless communication means with other computer devices; and
at least one peripheral device that selectively communicates with the wireless communication means;
wherein upon the peripheral device communicating with the wireless communication means, the control means of the wireless communication means establishing communication between the peripheral device and the wireless communication means resources.

10. A method for communication between a peripheral device and one or more programs resident on a wireless computer device, comprising the steps of:
starting a communication between a peripheral device and a wireless device having a computer platform with at least a communication portal, the computer platform including an operating system that manages wireless device resources and the interaction of the wireless device with other computer devices, and the computer platform further including one or more resident programs;
determining, at the operating system of the wireless device, the identity of peripheral device that has started communication with the wireless device; and
linking, with the operating system, the communication between the peripheral device and one or more resident programs of the wireless device.

11. The method of claim 10, wherein the step of starting a communication between a peripheral device and a wireless device occurs through a wired connection to the computer platform of the wireless device.

12. The method of claim 10, wherein the step of starting a communication between a peripheral device and a wireless device occurs through a wireless connection to the computer platform of the wireless device.

13. The method of claim 10, further comprising the steps of:
sending a device class identifier to the operating system of the wireless device; and
selecting at the operating system the appropriate handler for that peripheral device based upon the selected class.

14. The method of claim 10, further comprising the steps of:
sending a specific identifier to the operating system of the wireless device at the beginning of communication; and
identifying, at the operating system, the specific peripheral device in communication based upon a specific identifier of the peripheral device given at the beginning of communication.

15. The method of claim 10, wherein the step of starting a communication between a peripheral device and a wireless device occurs through the communication portal of the computer platform.

16. A method for communication between a peripheral device and the resident computer programs on a wireless computer device, comprising the steps of:
a step for starting a communication between a peripheral device and a wireless device having a computer platform with at least a communication portal, the computer platform including an operating system that manages wireless device resources and the interaction of the wireless device with other computer devices;
a step for determining, at the operating system of the wireless device, the identity of peripheral device that has started communication with the wireless device; and
a step for linking, with the operating system, the peripheral device with the one or more resident programs.

17. A device having a computer platform and at least a wireless communication portal, the computer platform including an operating system that manages device resources and the interaction of the wireless device with one or more other peripheral devices in communication with the device, the computer platform further including one or more resident programs, and wherein upon a peripheral device communicating with the computer platform of the wireless device, the operating system of the wireless device linking at least one or more resident programs with the peripheral device.

18. The device of claim 17, wherein the device communicates with a peripheral device through a wired connection from the computer platform of the wireless device.

19. The device of claim 17, wherein the wireless device communication with a peripheral device through a wireless connection from the computer platform of the wireless device.

20. The device of claim 17, wherein the operating system of the wireless device determines the type of peripheral device communicating with the wireless device based upon a device identifier sent from the peripheral device and selects the appropriate handler for that peripheral device based upon the selected class.

21. The device of claim 17, wherein the operating system of the wireless device identifies the specific peripheral device in communication based upon a specific identifier of the peripheral device given at the beginning of communication.

22. The device of claim 17, wherein communication of the peripheral device with the computer platform occurs through the communication portal.

23. A method at a wireless computer device for managing communication with a peripheral device, comprising the steps of:
receiving a communication from a peripheral device at a computer platform of the wireless device, the computer platform having at least a communication portal and including an operating system that manages wireless device resources and the interaction of the wireless device with other computer devices, the computer platform including one or more resident programs;
determining, at the operating system of the wireless device, the identity of the peripheral device that has started communication with the wireless device; and
linking, with the operating system, the peripheral device and one or more resident programs of the wireless device.

24. The method of claim 23, wherein the step of receiving a communication occurs through a wired connection to the computer platform of the wireless device.

25. The method of claim 23, wherein the step of receiving a communication occurs through a wireless connection to the computer platform of the wireless device.

26. The method of claim 23, further comprising the steps of:
receiving a device class identifier of the peripheral device at the operating system of the wireless device; and
selecting at the operating system the appropriate handler for that peripheral device based upon the class identifier.

27. The method of claim 23, further comprising the steps of:
receiving a specific identifier at the operating system of the wireless device at the beginning of communication; and
identifying, at the operating system, the specific peripheral device in communication based upon a specific identifier of the peripheral device given at the beginning of communication.

28. The method of claim 25, wherein the step of receiving a communication from a peripheral device occurs through the communication portal of the computer platform.

29. In a computer readable medium, a program that, when executed by a computer device having a computer platform with one or more resident programs and at least a wireless communication portal, and including an operating system that manages wireless device resources and the interaction of the wireless device with other computer devices, causes the computer device to perform the steps of:
determining, at the operating system, the identity of a peripheral computer device that has started communication with the wireless device; and
linking, with the operating system, the peripheral computer device and one or more resident programs on the computer platform of the computer device.

30. The program of claim 29, wherein the program causes the computer device communicate with the peripheral device through the wireless communication portal.

31. The program of claim 29, further causing the computer device to perform the steps of:
retrieving a device class identifier at the beginning of communication; and
selecting the appropriate handler for that peripheral device based upon the selected device class.

32. The program of claim 29, further causing the computer device to perform the steps of:
retrieving a specific peripheral device identifier at the beginning of communication; and
identifying the specific peripheral device in communication based upon the specific peripheral device identifier.
